(19) United States
(12) Patent Application Publication
(10) Pub. No.: US 2023/0149916 A1
(43) Pub. Date: May 18, 2023

(54) MEMBRANE FOR REMOVING ANIONIC MATERIALS

(71) Applicant: ENTEGRIS, INC., Billerica, MA (US)

(72) Inventors: Siddarth Sampath, Tyngsboro, MA (US); Ashutosh Shrikant Bhabhe, Zug (CH); James Hamzik, North Billerica, MA (US); Justin Brewster, North Billerica, MA (US)

(21) Appl. No.: 17/980,985

(22) Filed: Nov. 4, 2022

Related U.S. Application Data
(60) Provisional application No. 63/278,675, filed on Nov. 12, 2021.

(51) Int. Cl. B01J 47/12; B01J 41/14; B01J 41/04; B01D 71/78; B01D 71/82; B01D 71/26; B01D 69/12; B01D 71/60; C02F 1/44

(52) U.S. Cl. CPC B01J 47/12; B01J 41/14; B01J 41/04; B01D 71/78; B01D 71/82; B01D 71/261; B01D 69/1214; B01D 71/60; C02F 1/44; C02F 2101/105

(57) ABSTRACT

The disclosure provides a porous polymeric membrane having ionizable nitrogen functional groups at least at its surface, wherein such groups are associated with a hydroxide anion. The membranes are useful in the purification of polar solvents such as water and alcohols and are capable of removing trace amounts of anionic contaminants such as halides, phosphates, nitrates, nitrites, sulfites, and sulfates.

### CROSS-REFERENCE TO RELATED APPLICATIONS

This application claims the benefit under 35 USC 119 of U.S. Provisional Patent Application No. 63/278,675, filed Nov. 12, 2021, the disclosure of which is hereby incorporated herein by reference in its entirety.

### TECHNICAL FIELD

The disclosure relates generally to filter membranes and their use in the removal of anionic impurities from polar solvents, particularly solvents useful in semiconductor manufacturing processes including photoresist applications.

### BACKGROUND

Filter products are indispensable tools of modern industry, used to remove unwanted materials from a flow of a useful fluid. Useful fluids that are processed using filters include water, liquid industrial solvents and processing fluids, industrial gases used for manufacturing or processing (e.g., in semiconductor fabrication), and liquids that have medical or pharmaceutical uses. Unwanted materials that are removed from fluids include impurities and contaminants such as particles, microorganisms, and dissolved chemical species. Specific examples of filter applications include their use with liquid materials for semiconductor and microelectronic device manufacturing.

To perform a filtration function, a filter generally includes a filter membrane that is responsible for removing unwanted material from a fluid that passes through the filter membrane. The filter membrane may, as required, be in the form of a flat sheet, which may be wound (e.g., spirally), flat, pleated, or disk-shaped. The filter membrane may alternatively be in the form of a hollow fiber. The filter membrane can be contained within a housing or otherwise supported so that fluid that is being filtered enters through a filter inlet and is required to pass through the filter membrane before passing through a filter outlet.

A filter membrane can be constructed of a porous structure that has average pore sizes that can be selected based on the use of the filter, i.e., the type of filtration performed by the filter. Typical pore sizes are in the micron or sub-micron range, such as from about 0.001 micron to about 10 microns. Membranes with average pore size of from about 0.001 to about 0.05 micron are sometimes classified as ultrafilter membranes. Membranes with pore sizes between about 0.05 and 10 microns are sometimes referred to as microporous membranes.

A filter membrane having micron or sub-micron-range pore sizes can be effective to remove an unwanted material from a fluid flow either by a sieving mechanism or a non-sieving mechanism, or by both. A sieving mechanism is a mode of filtration by which a particle is removed from a flow of liquid by mechanical retention of the particle at a surface of a filter membrane, which acts to mechanically interfere with the movement of the particle and retain the particle within the filter, mechanically preventing flow of the particle through the filter. Typically, the particle can be larger than pores of the filter. A “non-sieving” filtration mechanism is a mode of filtration by which a filter membrane retains a suspended particle or dissolved material contained in flow of fluid through the filter membrane in a manner that is not exclusively mechanical, e.g., that includes an electrostatic mechanism by which a particulate or dissolved impurity is electrostatically attracted to and retained at a filter surface and removed from the fluid flow; the particle may be dissolved, or may be solid with a particle size that is smaller than pores of the filter medium.

The removal of ionic materials such as dissolved anions or cations from solutions is important in many industries, such as the microelectronics industry, where ionic contaminants and particles in very small concentrations can adversely affect the quality and performance of microprocessors and memory devices. The ability to prepare positive and negative photoresists with low levels of metal ion contaminants, or the ability to deliver isopropyl alcohol used in Maragoni drying for wafer cleaning with low part per billion or part per trillion levels of metal ion contaminants is highly desirable and are just two examples of the needs for contamination control in semiconductor manufacturing. Colloidal particles, which can be positively or negatively charged depending on the colloid chemistry and solution pH, can also contaminate process liquids and need to be removed. Dissolved ionic materials can be removed by way of a non-sieving filtration mechanism, by microporous filter membranes that are made of polymeric materials that attract dissolved ionic materials. Examples of such microporous membranes are made from chemically inert, low surface energy polymers like ultrahigh molecular weight polyethylene (“UPE”), polytetrafluoroethylene, and the like. Membranes have been used to remove metal contaminants from liquids in industries such as the microelectronic device industry. For example, photoresist solutions with ultralow levels of metal ion contaminants are desirable for low wafer defectivity and higher yields during high volume manufacturing of integrated circuits. Cation exchange membranes (i.e., negatively charged membranes) are the industry standard for removing such metal contamination from photoresist solutions used in the production of microchips.

Also desired in the microelectronic device industry are various solvents used in photoresist applications, particularly polar solvents having minimal anionic impurities. In particular, it is highly desired that polar solvents such as water and isopropanol have minimal anionic impurities—impurities such as halide (e.g., chloride), phosphates, nitrates, nitrites, sulfites, and sulfates.

### SUMMARY

The field of microelectronic device processing requires steady improvements in processing materials and methods to sustain parallel steady improvements in the performance (e.g., speed and reliability) of microelectronic devices. Opportunities to improve microelectronic device fabrication exist in all aspects of the manufacturing process, including methods and systems for filtering liquid materials.

A large range of different types of liquid materials are used as process solvents, cleaning agents, and other processing solutions, in microelectronic device processing. Many if not most of these materials are used at a very high level of purity. As an example, liquid materials (e.g., solvents) used in photolithography processing of microelectronic devices must be of very high purity. Specific examples of liquids that are used in microelectronic device processing include process solutions for spin-on-glass (SOG) techniques, for backside anti-reflective coating (BARC) methods, and for photolithography or wet etch and clean.

The disclosure provides a porous membrane having ionizable nitrogen functional groups at least at the surface of the membrane, wherein at least a portion of the ionizable nitrogen functional groups are associated with a hydroxide anion. As is more fully described below, these ionizable functional groups can be introduced to the surface of the membrane either via a grafting step or via coating with a curable coating prepared from monomeric species bearing the desired functional groups. In this fashion, at least a portion of the membrane thus possesses this coating, which then has available ionizable nitrogen functional groups which are able to interact with the fluids passing through the membranes and thereby remove undesired anionic contaminants.

The membranes are thus useful in the purification of polar solvents such as water and alcohols and are capable of removing trace amounts of anionic contaminants such as halides, phosphates, nitrates, nitrites, sulfites, and sulfates.

### BRIEF DESCRIPTION OF THE DRAWINGS

FIG. 1 illustrates the removal of chloride ion from a deionized water (DIW) sample.

FIG. 2 illustrates the removal of chloride ion from an isopropanol (IPA) sample.

FIG. 3 shows the results of an experiment involving a control membrane, i.e., prior to treatment with a hydroxide compound, and illustrates no effective chloride removal occurred. See Comparative Example 1

FIG. 4 shows the results of an experiment involving a control membrane, i.e., prior to treatment with a hydroxide compound, and illustrates no effective chloride removal occurred. See Comparative Example 2.

FIG. 5 shows the results of an experiment involving a control membrane, i.e., prior to treatment with a hydroxide compound, and illustrates no effective chloride removal occurred. See Comparative Example 3.

FIG. 6 shows the results of an experiment where the control membrane referred to above was treated with ammonium hydroxide and illustrates effective chloride removal occurred. See Example 1.

FIG. 7 is a plot of percent removal of bromide, chloride, fluoride, nitrate, nitrite, phosphate, and sulfate anions as a function tank turnover.

FIG. 8 is a plot of percent removal of bromide, chloride, fluoride, nitrate, sulfate and phosphate from 100% isopropanol in a single pass of the solvent through the membrane.

FIG. 9 (which is schematic and not necessarily to scale) shows an example of a filter product as described herein.

FIG. 10 is a plot of percent removal of fluoride, chloride, nitrite, sulfate, bromide, nitrate, and phosphate form a 50 ppb multi-anion challenge with a polyallylamine coated UPE membrane.

FIG. 11 is a plot of percent removal of fluoride, chloride, nitrite, sulfate, bromide, nitrate, and phosphate form a 2500 ppb multi-anion challenge with a polyallylamine coated UPE membrane.

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In one aspect, the disclosure provides a porous membrane having ionizable nitrogen functional groups at least at the surface of the membrane, wherein at least a portion of the ionizable nitrogen functional groups are associated with a hydroxide anion.

The porous membranes contemplated herein are not limited by the underlying material comprising the membrane. The porous membrane can be any suitable porous membrane, which can be structurally amorphous, crystalline, or any suitable morphologic combination thereof. The porous polymeric membrane can be made of any suitable polymer such as, for example, polyolefins (including fluorinated polyolefins), polyamides, polyacrylates, polyesters, nylons, polysulfones (PS), polyethersulfones (PES), celluloses, polycarbonates, single polymers, copolymers, composites, and combinations thereof. A particular embodiment includes membranes comprising a polyolefin. Suitable polyolefins include, but are not limited to, polyethylene, high density polyethylene, ultra-high molecular weight polyethylene, and combinations thereof. Suitable halocarbon polymers include, but not limited to, include polytetrafluoroethylene (PTFE), polychlorotrifluoro-ethylene (PCTFE), fluorinated ethylene polymer (FEP), polyhexafluoropropylene, and polyvinylidene fluoride and combinations of two or more thereof. In another embodiment, the membrane is comprised of polytetrafluorethyene.

In one embodiment, the porous polymeric membrane includes a polyethylene-based membrane referred to as ultra-high molecular weight polyethylene (UPE). UPE filter materials, such as UPE membranes, are typically formed from a resin having a molecular weight (viscosity average molecular weight) greater than about 1×10⁶ Daltons (Da), such as in the range of about 1×10⁶−9×10⁶Da, or 1.5×10⁶−9×10⁶Da.

In order to introduce the ionizable nitrogen functional group at or near the surface of the membrane, such groups may be either grafted to the polymeric membrane or can be introduced via a coating. In some embodiments, the coating may be a crosslinked polymer, for example a polymer, such as polyallylamine or polyvinylamine, mixed with a crosslinker, for example a difunctional crosslinker, such as poly(ethylene glycol) diglycidyl ether or 1,4-Butanediol diglycidyl ether. In some embodiments, the coating may be the result of a free radical polymerization of ionizable nitrogen-containing ethylenically-unsaturated monomers and optionally other ethylenically unsaturated monomers. The polymerization results in the coating covering at least a portion of the polymeric membrane surface, thereby resulting in ionizable nitrogen functional groups which are at least at the surface, thereby enabling the interaction of these ionizable nitrogen groups to interact with the fluid which is being purified by passing through the membrane.

In certain embodiments, the ethylenically-unsaturated monomers having ionizable nitrogen functional groups are chosen from 2-(dimethylamino)ethyl hydrochloride acrylate, [2-(acryloyloxy)ethyl]trimethylammonium chloride, 2-aminoethyl methacrylate hydrochloride, N-(3-aminopropyl) methacrylate hydrochloride, 2-(dimethylamino)ethyl methacrylate hydrochloride, [3-(methacryloylamino)propyl]trimethylammonium chloride solution, [2-(methacryloyloxy)ethyl]trimethylammonium chloride, acrylamidopropyl trimethylammonium chloride, 2-aminoethyl methacrylamide hydrochloride, N-(2-aminoethyl) methacrylamide hydrochloride, N-(3-aminopropyl)-methacrylamide hydrochloride, diallyldimethylammonium chloride, allylamine hydrochloride, vinyl imidazolium hydrochloride, vinyl pyridinium hydrochloride, and vinyl benzyl trimethyl ammonium chloride, either individually or in combinations of two or more thereof, and the like. In a particular embodiment, the ethylenically-unsaturated monomers having ionizable nitrogen functional groups includes acrylamido propyl trimethylammonium chloride (APTAC). It should be appreciated that some ethylenically-unsaturated monomers having at least one ionizable nitrogen functional group as set forth above, comprise a quaternary ammonium group and are naturally charged in a polar solvent while other monomers with a positive charge such as comprising primary, secondary and tertiary amines can be adjusted to create charge by treatment with an acid. It should also be appreciated that this free-radical polymerized coating can be prepared using the chloride or hydrochloride salt forms of the monomers as recited above, or can be converted to a different halide or hydrohalide form, or converted to the hydroxide form prior to polymerization. In either event, as more fully described below, the coating once formed will be treated with a hydroxide compound such as an alkyl or aryl phosphonium hydroxide, ammonium hydroxide, or an organic ammonium hydroxide to convert the ionizable nitrogen-containing functional group to one which is associated with a hydroxide anion, thus rendering it useful in the present invention to reduce or remove anionic contaminants such as halides, phosphates, nitrates, nitrites, sulfites, and sulfates from polar solvents.

In certain embodiments, the underlying polymeric membrane has a free-radical polymerized coating is prepared from about 1 to about 25 weight percent of ethylenically-unsaturated monomers having ionizable nitrogen functional groups. In other embodiments, the underlying polymeric membrane has a free-radical polymerized coating is prepared from about 2 to about 15 weight percent of ethylenically-unsaturated monomers having ionizable nitrogen functional groups. In other embodiments, the underlying polymeric membrane has a free-radical polymerized coating is prepared from about 3 to about 10 weight percent of ethylenically-unsaturated monomers having ionizable nitrogen functional groups. As referred to herein, the weight percent of the ethylenically-unsaturated monomer is the weight of the monomer referenced in terms of the total weight of the solution, i.e., reaction solvent plus all other monomers utilized in the polymerization reaction.

In addition to the ethylenically-unsaturated monomers having at least one ionizable nitrogen functional group, the free-radical polymerized coating can be prepared from additional ethylenically-unsaturated monomers which do not possess the at least one ionizable nitrogen functional group, and can be categorized as uncharged, negatively-charged, or zwitterionic in character. Such monomers are well known and include various vinyl and (meth)acrylic monomers, which can be charged, e.g., acrylic or methacrylic acids, or uncharged, for example acrylic or methacrylic esters, or zwitterionic in character. Additionally, the free-radical polymerized coating can contain difunctional compounds to effectively serve as crosslinkers.

Exemplary crosslinkers include methylene bis acrylamide (MBAm), triallylamine, tetraethylene glycol diacrylate, tetraethylene glycol diamethacrylate, divinyl sulfone, divinyl benzene, 1,3,5-Triallyl-1,3,5-triazine-2,4,6(1H,3H,5H)-trione 98%, and ethylene glycol divinyl ether. In one embodiment, the crosslinker is methylene bis acrylamide.

Examples of monomers with negative charges in an organic liquid that can be used in the coating can include, but are not limited to, 2-ethylacrylic acid, acrylic acid, 2-carboxyethyl acrylate, 3-sulfopropyl acrylate potassium salt, 2-propyl acrylic acid, 2-(trifluoromethyl)acrylic acid, methacrylic acid, 2-methyl-2-propene-1-sulfonic acid sodium salt, mono-2-(methacryloyloxy)ethyl maleate, 3-sulfopropyl methacrylate potassium salt, 2-acrylamido-2-methyl-1-propanesulfonic acid, 3-methacrylamido phenyl boronic acid, vinyl sulfonic acid, and vinyl phosphonic acid, either individually or combinations of two or more thereof. In a particular embodiment, the monomer with negative charge includes sulfonic acid. In one embodiment, the monomer with a negative charge is vinyl sulfonic acid or a salt thereof. It should be appreciated that some monomers with a negative charge listed above, comprise a strong acid group and are naturally charged in organic solvent while other monomers with a negative charge comprising weak acids are adjusted to create charge by treatment with base. Monomers which are negatively charged in an organic solvent, either naturally or by treatment can be polymerized and cross-linked with a cross-linker to form a coating on a porous membrane that is negatively charged in an organic solvent.

Examples of uncharged ethylenically-unsaturated monomers include vinyl acetate, vinyl butyrate, vinyl caprylate, and C₁-C₁₈ alkyl (meth)acrylates. Further examples include methyl acrylate, methyl methacrylate, ethyl acrylate, ethyl methacrylate, butyl acrylate, butyl methacrylate, isobutyl acrylate, isobutyl methacrylate, ethylhexyl acrylate, ethylhexyl methacrylate, octyl acrylate, octyl methacrylate, styrene, α-methyl styrene, glycidyl methacrylate, alkyl crotonates, vinyl acetate, vinyl caprylate, di-n-butyl maleate, di-octylmaleate, and the like.

Examples of zwitterionic monomers include [3-(methacryloylamino)propyl]di-methyl(3-sulfopropyl)ammonium hydroxide; [2-(methacryloyloxy)ethyl]dimethyl-(3-sulfopropyl)ammonium hydroxide; 2-(methacryloyloxy)ethyl 2-(trimethylammonio)ethyl Phosphate; and 1-(3-Sulfopropyl)-2-vinylpyridinium hydroxide either individually or combinations of two or more thereof.

In one embodiment, the underlying polymeric membrane is at least partially coated with a free-radical polymerized polymer, wherein the polymer is prepared from monomers comprising about 3 to about 10 weight percent of acrylamido propyl trimethylammonium chloride, as well as dimethylacrylamide and methylene bis acrylamide.

By way of illustration, polymerization and cross-linking of the polymerizable monomer onto the porous membrane substrate can be effected so that a select portion or the entire surface of the porous membrane, including the inner surfaces of the porous membrane, is modified with a cross-linked polymer. It should be understood that various embodiments of the coated porous polymeric membrane encompass cross-linking as much of the surface of the membrane as desired from greater than 0% to 100%. It should also be understood that embodiments also encompass other technique such as grafting (as further discussed below) and a combination of techniques such as a portion is cross-linked and a portion is grafted. Embodiments also encompass cross-linking a grafted portion.

By way of example, a reagent bath comprised of: (1) at least one polymerizable monomer which is a ethylenically unsaturated monomer having at least one ionizable nitrogen functional group, and optionally another ethylenically unsaturated monomer, (2) a polymerization initiator, if needed, and optionally (3) a cross-linking agent in a polar solvent such as a water soluble solvent for these three constituents, is contacted with the porous polymeric membrane substrate under conditions to effect polymerization and crosslinking of the monomers and deposition of the resulting cross-linked polymer onto the porous polymeric membrane substrate. Even though the solvent is a polar solvent, the requisite degree of membrane surface modification may be and is obtained. When the monomers are difunctional or have higher functionality, an additional cross-linking agent is not needed but may be used. Representative suitable polar solvents include solvents having a dielectric constant above 25 at room temperature such as polyols including 2-methyl-2,4-pentanediol, 2,4 pentanedione, glycerine or 2,2′-thiodiethanol; amides such as formamide, dimethyl formamide, dimethyl acetamide; alcohols such as methanol, or the like; and nitro substituted aromatic compounds including nitrobenzene, 2-furaldehyde, acetonitrile, 1-methyl pyrrolidone or the like. The particular solvent is chosen to solublize the cross-linking agent, the monomer(s) and the initiator, if present.

Suitable initiators and cross-linking agents for the monomers described above can be used. For example, when utilizing charged alkyl groups as the polymerizable monomer, suitable photopolymerization initiators include benzophenone, 4-(2-hyroxyethoxy)phenyl-(2-hydroxy-2-propyl) ketone, azoisopropane or 2,2-dimethoxy-2-phenylacetophenone or the like. Suitable thermal initiators include organic peroxides such as dibenzoyl peroxide, t-butylhydroperoxide, cumylperoxide or t-butyl perbenzoate or the like and azo compounds such as azobisisobutyronitrile (AIBN) or 4,4,′-azobis(4-cyanovaleric acid) or the like. Representative suitable cross-linking agents include 1,6-hexanediol diacrylate, tetraethylene glycol diacrylate; 1,1,1-trimethylolpropane triacrylate or the like; N,N′-methylene bisacrylamide or the like, either individually or combinations of two or more thereof.

In one embodiment, polymerizable monomer is present in the reactant solution at a concentration between about 2% and about 20%, or alternately between about 3% and about 10% based upon the weight of the total solution. The cross-linking agent is present in one embodiment in an amount of between about 2% and about 10% by weight, based upon the weight of the polymerizable monomer. Greater amounts of cross-linking agents can be used. The polymerization initiator is present in an amount of between about 1% and about 10% by weight, based upon the weight of the polymerizable monomer. As noted above, the cross-linking agent can be utilized without the monomer and thereby functions as the polymerizable monomer.

Polymerization and cross-linking can be effected by exposing the monomer reaction system to ultraviolet (UV) light, thermal sources or ionizing radiation. The polymerization and crosslinking is effected in an environment where oxygen does not inhibit polymerization or crosslinking. The process is conveniently effected by dipping the membrane substrate in the solution containing the monomer, crosslinking agent, and the initiator, sandwiching the membrane between two ultraviolet light transparent sheets, such as polyethylene, or in a blanket of an inert gas such as nitrogen and exposing to UV light. The process can be effected continuously and the desired cross-linked coating is formed after UV exposure is initiated. By controlling the reactant concentrations and UV exposure, as set forth above, a composite membrane is produced which is nonplugged and has essentially the same porous configuration as the membrane substrate.

Further disclosure on the formation of and composition of such coatings on the surface of a porous polymeric membrane can be found in U.S. Patent Publication No. 2020/0206691, incorporated herein in its entirety for all purposes.

In a further embodiment, membranes which can be treated with a hydroxide compound and utilized as described herein include those available from Entegris, Inc., under the mark Purasol™ SN.

Exemplary hydroxide compounds which can be used to convert the coating to one which includes ionizable nitrogen functional groups associated with a hydroxide ion include those hydroxide compounds which do not also include alkaline or alkaline earth metal counterions. Exemplary hydroxide compounds thus include ammonium hydroxide, tetramethylammonium hydroxide, tetraethylammonium hydroxide, tetrapropylammonium hydroxide, tetrabutylammonium hydroxide, tributylmethylammonium hydroxide, benzyltrimethylammonium hydroxide, choline hydroxide, tetrabutylphosphonium hydroxide, tetramethylphosphonium hydroxide, tetraethylphosphonium hydroxide, tetrapropylphosphonium hydroxide, benzyltriphenylphosphonium hydroxide, methyl triphenylphosphonium hydroxide, ethyl triphenylphosphonium hydroxide, and N-propyl triphenylphosphonium hydroxide.

In another embodiment, the ionizable nitrogen functional groups are grafted to the membrane. In this process, the desired ionizable nitrogen-containing ethylenically unsaturated monomer can be attached to a filter material via grafting from the membrane. Grafting refers to chemically linking a moiety, such as a monomer or other molecule, to polymeric porous membrane surfaces, including inner pore surfaces, of a porous membrane. “Grafting” in this context can be accomplished by irradiation of the filter material in the presence of a photo-initiator and an unsaturated monomer containing the desired the polycarboxyl ligand (see, for example, WO2016/081729 A1 (Jaber et al.), US Patent Publication Nos. 2021/0260537; 2020/0406201; 2020/0254398; 2020/0206691; 20200171442; 2019/0282961; 2018/0290109; 2018/0185835; 2016/0144322; and U.S. Pat. No. 10,792,620, each of which is incorporated herein by reference in their entireties for all purposes). In another mode of practice, the filter material can be attached with the desired ionizable nitrogen-containing ethylenically-unsaturated monomer via grafting from the membrane using electron beam or gamma irradiation. Grafting using electron beam or gamma irradiation can be accomplished using techniques known as pre-irradiation grafting or simultaneous irradiation grafting.

For grafting a functional group onto a polymer that has a hydrophobic surface, e.g., polyethylene, the use of a hydrophobic photoinitiator may work well. For other polymers, especially polymers such as nylons that exhibit a hydrophilic surface, these techniques are not as effective. In such cases, the methodology described in US Patent Publication 2020/01714422, incorporated herein by reference, may be utilized. In general, the technique involves applying a hydrophobic photoinitiator, in solution, to a surface of a hydrophilic polymer followed by an optional drying step and then re-wetting the surface with a monomer solution. The techniques can ensure that a relatively high level of photoinitiator is deposited on the surface of the hydrophilic polymer. The level of photoinitiator that is presented to the surface is sufficient to allow grafting of a charged monomer onto the hydrophilic surface in an amount that will be useful or advantageously high with respect to allowing the hydrophilic polymer (as part of a filter membrane) to be effective as a filter membrane. The steps of chemically attaching the ionic groups onto hydrophilic polymer of a filter membrane do not have any substantial effect on the amount (flow rate or flux) of fluid that can be passed through the filter membrane—the amount (rate or flow) of fluid that can be passed through the filter membrane is not substantially detrimentally affected by chemically adding the ionic groups to the filter membrane. At the same time, the filtering performance of the filter membrane, especially non-sieving filtering as measured by dye-binding capacity, particle retention, and metal ion removal, can be improved by a significant amount.

The filter membranes thus afforded by the disclosure are useful in the removal of at least a portion of anionic species in a polar solvent. Accordingly, in another aspect, the disclosure provides a method for removing anionic contaminants from a polar solvent composition, which comprises passing said composition through the membranes of the disclosure. In this fashion, as much as 50 (weight) percent, 60 percent, 70 percent, 80 percent, 90 percent, 95 percent, or about 99 percent of the anionic contaminants in a polar solvent may be removed.

In certain embodiments, the polar solvent composition is comprised of a solvent chosen from at least one of water, C₁-C₆ alcohols, glycols, and glycol ethers. Exemplary solvents include water, methanol, ethanol, isopropanol, butanol, C₂-C₄ diols, C₂-C₄ triols, tetrahydrofurfuryl alcohol, 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol), dichloromethane, chloroform, acetic acid, propionic acid, trifluoroacetic acid, tetrahydrofuran, N-methylpyrrolidinone, cyclohexylpyrrolidinone, N-octylpyrrolidinone, N-phenylpyrrolidinone, methyldiethanolamine, methyl formate, N, N-dimethyl formamide, dimethylsulfoxide, tetramethylene sulfone, diethyl ether, phenoxy-2-propanol, propriophenone, ethyl lactate, ethyl acetate, ethyl benzoate, acetonitrile, acetone, ethylene glycol, propylene glycol, 1,3-propanediol, dioxane, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, propylene glycol phenyl ether, ethylene glycol monophenyl ether, diethylene glycol monophenyl ether hexaethylene glycol monophenylether, dipropylene glycol methyl ether acetate, tetraethylene glycol dimethyl ether, dibasic ester, glycerine carbonate, N-formyl morpholine, triethyl phosphate, and combinations thereof.

In one embodiment, the C₁-C₆ alcohol is isopropanol.

In one embodiment, the anionic contaminant to be removed by the membranes of the disclosure is chosen from one or more of halides, phosphates, nitrates, nitrites, sulfites, and sulfates. In another embodiment, the anionic contaminant to be removed is chosen from phosphates, chlorides, and fluoride ions.

The membranes of the invention can be utilized in conjunction with one or more filters or membranes which are other than the membranes of the disclosure. This utilization can range from merely using such other filters and membranes in series with the membranes of the disclosure or by combining such other filters and membranes with the membranes of the disclosure in a unified structure. Accordingly, in a further aspect, the disclosure provides a composite membrane comprising:
a first membrane and a second membrane, an output facing surface of the first membrane in contact with an input facing surface of the second membrane,
wherein the first membrane or the second membrane comprises a porous membrane having ionizable nitrogen functional groups at or near the surface of the membrane, wherein at least a portion of the ionizable nitrogen functional groups are associated with a hydroxide anion;
and the second membrane is different from the first membrane.

In one embodiment, the second membrane is capable of removing cationic materials from a polar solvent. Many such filter materials are commercially available, or are otherwise known. See for example PURASOL™ SP solvent purifiers, Protego® Plus HT, and HTX Purifiers, and Protego® Plus LT purifiers, available from Entegris, Inc. See also, US Patent Publication No. 2020/0206691 and U.S. Pat. No. 10,792,620, incorporated herein by reference in their entirety for all purposes.

The membranes described herein can have a variety of geometric configurations, such as a flat sheet, a corrugated sheet, a pleated sheet, and a hollow fiber, among others. The porous polymeric membrane can have a pore structure that can be isotropic or anisotropic, skinned or unskinned, symmetric or asymmetric, any combination of these or can be a composite membrane including one or more retentive layers and one or more support layers. Furthermore, the coated porous membrane can be supported or unsupported by webs, nets, and cages, among others.

A membrane as described can be contained within a larger filter structure such as a multilayer filter assembly or a filter cartridge that is used in a filtering system. The filtering system will place the filter membrane, e.g., as part of a multi-layer filter assembly or as part of a filter cartridge, in a filter housing to expose the filter membrane to a flow path of a liquid chemical to cause at least a portion of the flow of the liquid chemical to pass through the filter membrane, so that the filter membrane removes an amount of the impurities or contaminants from the liquid chemical. The structure of a multi-layer filter assembly or filter cartridge may include one or more of various additional materials and structures that support the composite filter membrane within the filter assembly or filter cartridge to cause fluid to flow from a filter inlet, through the composite membrane (including the filter layer), and thorough a filter outlet, thereby passing through the composite filter membrane when passing through the filter. The filter membrane supported by the filter assembly or filter cartridge can be in any useful shape, e.g., a pleated cylinder, a cylindrical pad, one or more non-pleated (flat) cylindrical sheets, a pleated sheet, among others. Accordingly, in a further aspect, the disclosure provides a filter comprising one or more of the membranes or composite membranes as set forth herein.

One example of a filter structure that includes a filter membrane in the form of a pleated cylinder can be prepared to include the following component parts, any of which may be included in a filter construction but may not be required: a rigid or semi-rigid core that supports a pleated cylindrical coated filter membrane at an interior opening of the pleated cylindrical coated filter membrane; a rigid or semi-rigid cage that supports or surrounds an exterior of the pleated cylindrical coated filter membrane at an exterior of the filter membrane; optional end pieces or “pucks” that are situated at each of the two opposed ends of the pleated cylindrical coated filter membrane; and a filter housing that includes an inlet and an outlet. The filter housing can be of any useful and desired size, shape, and materials, and can preferably be made of suitable polymeric material.

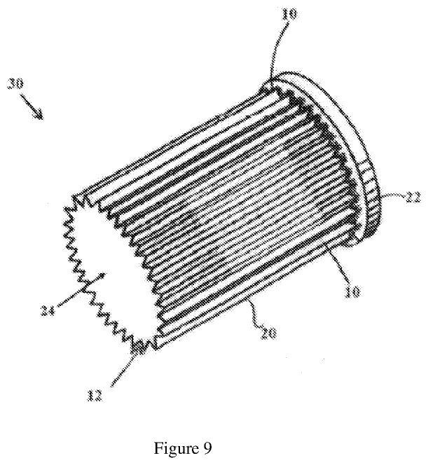

As one example, FIG. 9 shows filter component 30, which is a product of pleated cylindrical component 10 and end piece 22, with other optional components. Cylindrical component 10 includes a filter membrane 12, as described herein, and is pleated. End piece 22 is attached (e.g., “potted”) to one end of cylindrical filter component 10. End piece 22 can preferably be made of a melt-processable polymeric material. A core (not shown) can be placed at the interior opening 24 of pleated cylindrical component 10, and a cage (not shown) can be placed about the exterior of pleated cylindrical component 10. A second end piece (not shown) can be attached (“potted”) to the second end of pleated cylindrical component 30. The resultant pleated cylindrical component 30 with two opposed potted ends and optional core and cage can then be placed into a filter housing that includes an inlet and an outlet and that is configured so that an entire amount of a fluid entering the inlet must necessarily pass through filtration membrane 12 before exiting the filter at the outlet.

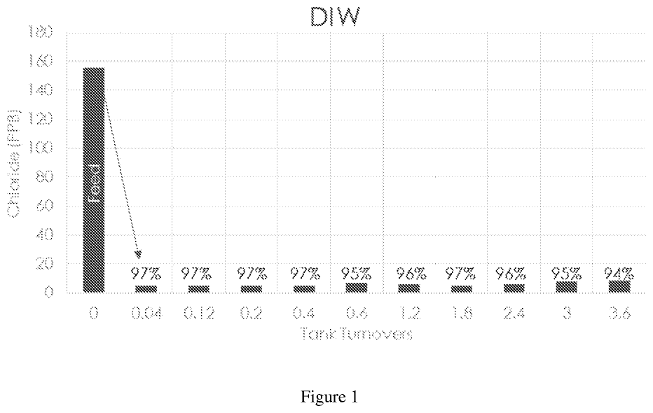

An additional filter structure can be the one shown as FIG. 1B in U.S. Patent Publication No. 2020/0206691.

### EXAMPLES

As noted above, exemplary membranes having ionizable nitrogen functional groups can be prepared as set forth in U.S. Patent Publication No. 2020/0206691, incorporated herein in its entirety for all purposes. Examples 2 and 4 from this publication is set forth below as Preparations 1 and 2.

Preparation 1

This example demonstrates the preparation of surface modification solution containing monomers with positive charges, as well as a radical initiator i.e., materials to form coating. In a representative experiment, a solution was made containing: 0.3% Irgacure 2959, 3.5% Methanol 5.6% Acrylamido propyl trimethylammonium Chloride (APTAC), 1.2% Dimethyl acrylamide (DMAm) and 1.2% methylene bis acrylamide (MBAm) cross linker, 88.2% water.

Preparation 2

This example demonstrates how a polyethylene membrane is surface modified to with coating having polymerized monomer with positive charge.

In a representative experiment, 47 mm disk of UPE membrane (9 psi average mean bubble point in isopropanol (IPA)(Entegris, Inc.) was wet with IPA solution for 25 sec. An exchange solution comprising 10% hexylene glycol and 90% water was used to rinse the membrane and remove IPA. The membrane disk was then introduced into the surface modification solution described in Preparation 1. The dish was covered and the membrane was soaked in the solution for 2 minutes. The membrane disk was removed and placed between 1 mil polyethylene sheets. The excess solution was removed by rolling a rubber roller over the polyethylene/membrane disk/polyethylene sandwich as it lays flat on a table. The polyethylene sandwich was then taped to a transport unit which conveyed the assembly through a Fusion Systems broadband UV exposure lab unit emitting at wavelengths from 200 to 600 nm. Time of exposure was controlled by how fast the assembly moves through the UV unit. In this example, the assembly moved through the UV chamber at 10 feet per minute. After emerging from the UV unit, the membrane was removed from the sandwich and immediately placed in DI water; where the membrane was washed by swirling for 5 minutes. Next, the treated membrane sample was washed in methanol for 5 minutes. Following this washing procedure the membrane was dried on a holder in an oven operating at 50.degree. C. for 10 min. The IPA flow time of the membrane modified as described above was 240 sec.

### Comparative Example 1

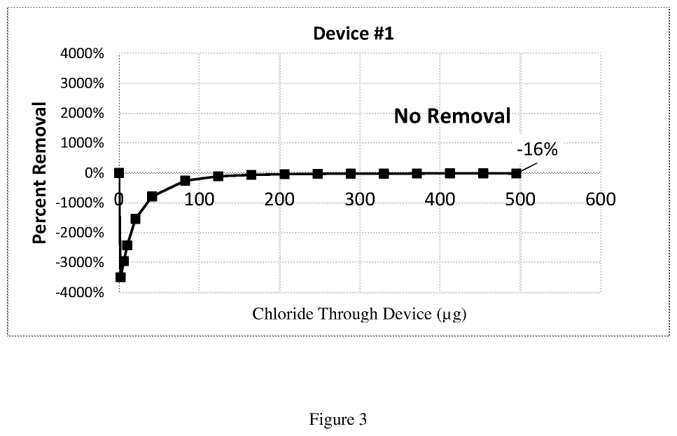

A filter device (Device 1) containing a membrane prepared according to a process similar to Preparation 1 above, was pre-treated with a deionized water (DIW) flush only (5 minutes), and then challenged with a DIW solution spiked with chloride ions. The results, as set forth in FIG. 3 show that there is no removal of chlorides over the period of the challenge and in act one observes a release of chloride ion, resulting in a negative removal percentage during the initial stages of the experiment.

### Comparative Example 2

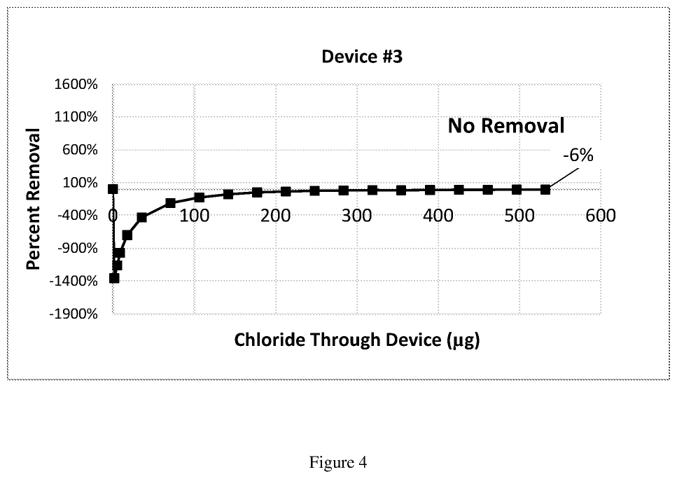

A filter device (Device 3) containing a membrane prepared according to a process similar to Preparation 1 above, was pre-treated twice with DIW soaking steps, once at room temperature (for 16 hours) and once at high temperature (50° C. for 16 hours) and then challenged with a DIW solution spiked with chloride ions. The results, as set forth in FIG. 4, show that there is no removal of chlorides and in fact one observes a release of chloride ion, resulting in a negative removal percentage during the initial stages of the experiment.

### Comparative Example 3

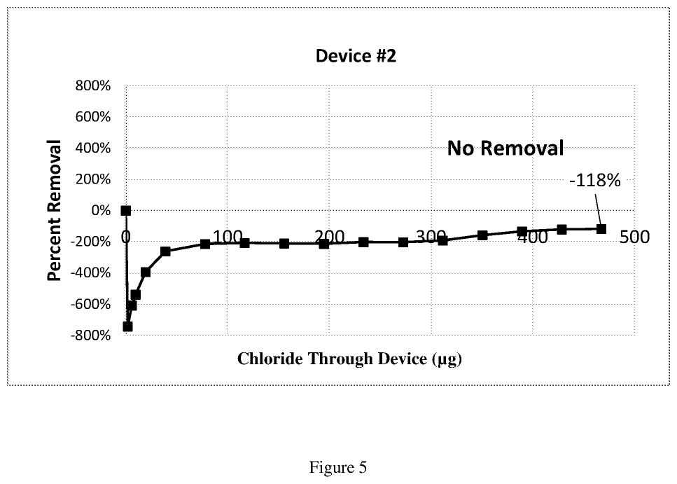

A filter device (Device 2) containing a membrane prepared according to a process similar to Preparation 1 above, was pre-treated with a DIW flush (5 minutes), followed by a high temperature DIW soak (50° C. for 24 hours) and then challenged with a DIW solution spiked with chloride ions. The results, as set forth in FIG. 5, show that there is no removal of chlorides over the period of the challenge, and in fact one observes a release of chloride ion, resulting in a negative removal percentage during the initial stages of the experiment.

### Example 1

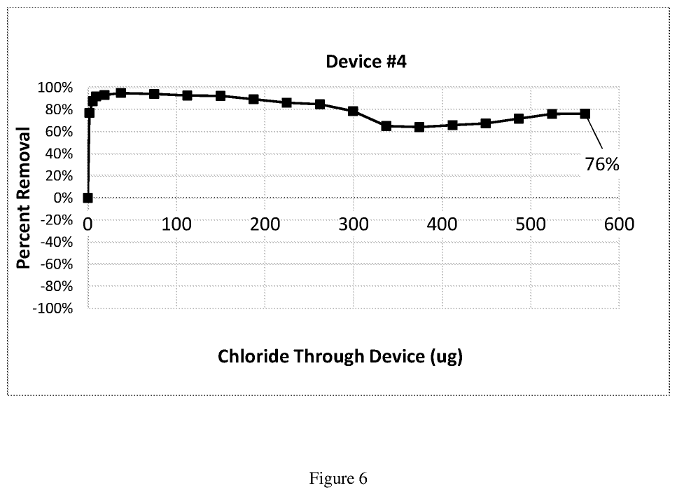

A filter device (Device 4) containing a membrane prepared according to a process similar to Preparation 1 above, was pre-treated with multiple 1% NH₄OH and DIW soaks only (1% NH₄OH 30-minute soak, 16-hour 50° C. DIW soak, followed by 1% NH₄OH 30 minute flush, then a 30 minute DIW flush), and then challenged with a DIW solution spiked with chloride ions. (The soaks/flushes described herein were done after the membrane was placed in the filter structure.) The results, as set forth in FIG. 6, show good removal of chloride ion over the period of the challenge.

Referring to the data in FIG. 1, a filter device containing treated membrane of Example 1 is challenged with 150 ppb chloride ions spiked DIW solution in a recirculated system with samples taken at periodic time intervals represented by tank turnovers at that time point. A tank turnover is defined as the ratio of the feed volume to the recirculation flow rate (Example: With a feed volume of 500 mL and recirculation flow rate of 100 mL/min, 1 tank turnover corresponds to 5 minutes). The result shows that there is >94% removal of Chlorides over the period of test.

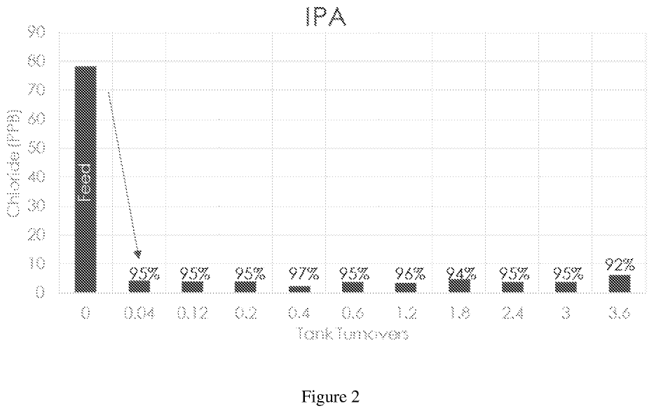

Referring to the data in FIG. 2, a filter device containing treated membrane of Example 1 is challenged with 75 ppb chloride ions spiked 100% isopropanol solution in a recirculated system with samples taken at periodic time intervals represented by tank turnovers at that time point. A tank turnover is defined as the ratio of the feed volume to the recirculation flow rate (Example: With a feed volume of 500 mL and recirculation flow rate of 100 mL/min, 1 tank turnover corresponds to 5 minutes). The results show that there is >92% removal of chlorides over the period of test.

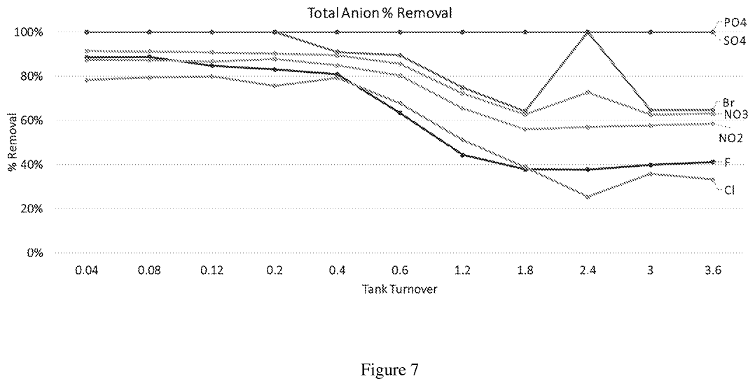

FIG. 7 is a plot of percent removal of anions namely bromide, chloride, fluoride, nitrate, nitrite, phosphate, and sulfate as a function of tank turnover. Here, a filter device containing treated membrane (same as FIG. 1) is challenged with DIW containing each of the specified ions spiked at variable levels (Concentrations for each ion are between 20 ppb-250 ppb) in a recirculated system with samples taken at periodic time intervals represented by tank turnovers at that time point. The results show that the % removal of an ion is a strong function of its oxidation state. Ions like Sulfates and Phosphates with a higher absolute oxidation state of 2 and 3, respectively, are removed completely (100%) and stably as a function of tank turnover. For other ions like bromide, chloride, fluoride, nitrate and nitrite—we see varying absolute removal as a function of tank turnover with final removal being dependent on the specific anion. Specifically, bromide, nitrite & nitrate show removal of ˜60%; while chloride and fluoride have removal of ˜40%.

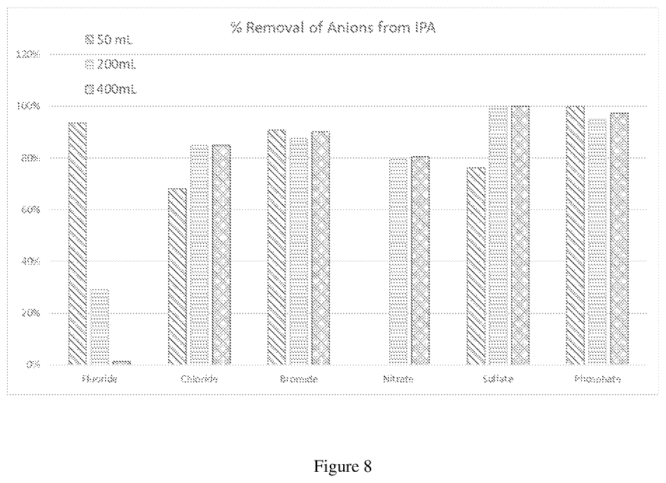

FIG. 8 is a plot of percent removal of bromide, chloride, fluoride, nitrate, sulfate and phosphate anions from 100% isopropanol in a single pass of the solvent through the membrane. Here a 47 mm (diameter) coupon of the treated membrane (same as membrane as in FIG. 1) is challenged with 100% isopropanol spiked with 20 ppb each of the specified ions in a single pass system with samples taken at periodic volume-based intervals. The results show that % removal of ions is dependent on the specific anion. For sulfate and phosphate, removal is >95%; for bromide, chloride, and nitrate removal is >80%; and for fluoride, the removal is dependent on the volume of spiked 100% isopropanol that is passed through the membrane—higher the volume that passes through, lower is the removal.

### Example 2

A hydrophilic ultrahigh molecular weight polyethylene (UPE) membrane sheets with a pore size of about 0.65 microns were surface modified with a crosslinked polyallylamine coating using the following method. First, a coating solution was made containing 10% polyallylamine (average MW about 15,000) and 0.5% poly(ethylene)glycol diglycidyl ether (MW about 500) by weight. The hydrophilic UPE membrane sheets were submerged in the coating solution for about 1 minute so that the membrane was imbibed in the solution. Next, the membrane was removed from the coating solution and placed between two polyethylene sheets and the excess coating solution was nipped off with a rubber roller. Next, the membranes were restrained between two Teflon coated metal frames and were allowed to dry at room temperature for about 16 hours to allow curing to take place. The membranes were removed from the frames and washed with deionized water and 10% hydrochloric acid several times, and then washed with methanol and placed between the Teflon coated metal frames again and allowed to dry. The resulting hydrophilic UPE membrane coated with crosslinked polyallylamine (PAA membrane) was cut into 47 mm diameter coupons.

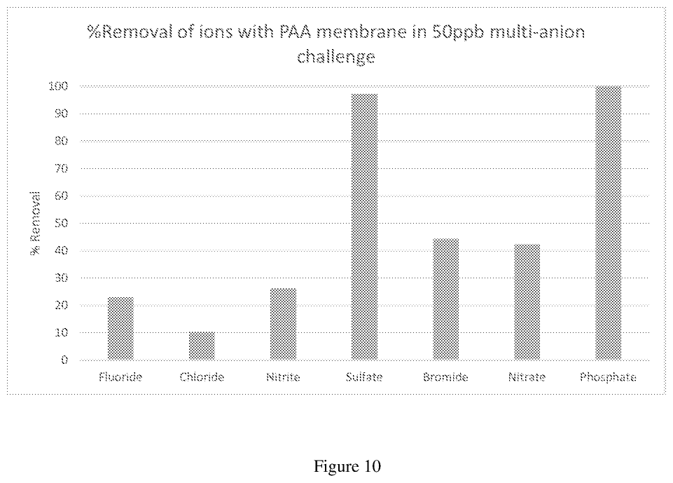

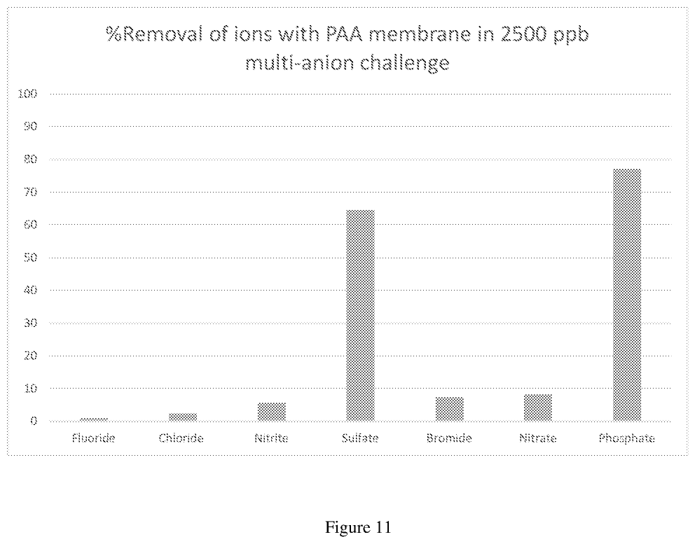

The coupons were soaked in a bottle containing a challenge solution with fluoride, chloride, nitrite, sulfate, bromide, nitrate, and phosphate anions at two different concentrations (50 ppb and 2500 ppb of each ion). A sample of each challenge solution was collected in a sample bottle for analysis to act as the “Feed” value. The solutions containing the membranes were placed on a rotary mixer and left mixing for about 24 hours and then a deionized water solution was aliquoted into the sample bottles and the solutions were analyzed by ion chromatography (IC). FIG. 10 shows the % of removal of the ions relative to the “Feed” concentration in the challenge solution for the 50 ppb challenge and FIG. 11 shows the same for the 2500 ppb challenge. As can be seen, the PAA membrane has high removal for sulfate and phosphate anions.

Aspects

In a first aspect, the disclosure provides a porous membrane having ionizable nitrogen functional groups at least at the surface of the membrane, wherein at least a portion of the ionizable nitrogen functional groups are associated with a hydroxide anion.

In a second aspect, the disclosure provides the membrane of the first aspect, wherein the membrane is capable of removing anionic contaminants from a polar solvent composition.

In a third aspect, the disclosure provides the membrane of the first or second aspect, wherein the anionic contaminants are chosen from chloride, fluoride, bromide, nitrate, nitrite, sulfate, and phosphate ions.

In a fourth aspect, the disclosure provides the membrane of any one of the first, second, or third aspects, wherein the ionizable nitrogen functional groups are grafted to the membrane.

In a fifth aspect, the disclosure provides the membrane of any one of the first second, or third aspects, having a coating and wherein the ionizable nitrogen functional groups are at least at the surface of the coating on the membrane.

In a sixth aspect, the disclosure provides the membrane of the fifth aspect, wherein the coating is a polymeric material formed from the free radical reaction of ethylenically-unsaturated monomers, wherein at least a portion of the ethylenically-unsaturated monomers are ethylenically-unsaturated monomers having ionizable nitrogen functional groups.

In a seventh aspect, the disclosure provides the membrane of the sixth aspect, wherein the ethylenically-unsaturated monomers having ionizable nitrogen functional groups are chosen from 2-(dimethylamino)ethyl acrylate, [2-(acryloyloxy)ethyl]trimethylammonium, 2-aminoethyl methacrylate, N-(3-aminopropyl) methacrylate, 2-(dimethylamino)ethyl methacrylate, [3-(methacryloylamino)propyl] trimethylammonium, [2-(methacryloyloxy)ethyl]trimethylammonium, acrylamidopropyl trimethylammonium, 2-aminoethyl methacrylamide, N-(2-aminoethyl) methacrylamide, N-(3-aminopropyl)-methacrylamide, diallyldimethylammonium, allylamine, vinyl imidazolium, vinyl pyridinium, and vinyl benzyl trimethyl ammonium, or a hydroxide, or a halide or hydrohalide salt thereof.

In an eighth aspect, the disclosure provides the membrane of the sixth or seventh aspect, wherein the ethylenically-unsaturated monomer having ionizable nitrogen functional groups comprises acrylamido propyl trimethylammonium chloride.

In a ninth aspect, the disclosure provides the membrane of any one of the sixth, seventh, or eighth aspects, wherein the ethylenically-unsaturated monomers are further chosen from monomers which are uncharged, negatively-charged, or zwitterionic.

In a tenth aspect, the disclosure provide the membrane of the fifth aspect, wherein the coating is a polyallylamine or a polyvinylamine

In an eleventh aspect, the disclosure provides the membrane of any one of the first through the ninth aspects, wherein the membrane has been treated with an alkyl or aryl phosphonium hydroxide, ammonium hydroxide, or an organic ammonium hydroxide.

In twelfth aspect, the disclosure provides the membrane of the eleventh aspect, wherein the hydroxide compound is chosen from ammonium hydroxide, tetramethylammonium hydroxide, tetraethylammonium hydroxide, tetrapropylammonium hydroxide, tetrabutylammonium hydroxide, tributylmethylammonium hydroxide, benzyltrimethylammonium hydroxide, choline hydroxide, tetrabutylphosphonium hydroxide, tetramethylphosphonium hydroxide, tetraethylphosphonium hydroxide, tetrapropylphosphonium hydroxide, benzyltriphenylphosphonium hydroxide, methyl triphenylphosphonium hydroxide, ethyl triphenylphosphonium hydroxide, N-propyl triphenylphosphonium hydroxide.

In a thirteenth aspect, the disclosure provides the membrane of any one of the sixth, seventh, or eighth aspects, wherein the ethylenically-unsaturated monomer having ionizable nitrogen functional groups is a quaternary ammonium group associated with a hydroxyl anion.

In a fourteenth aspect, the disclosure provides the membrane of any one of the sixth, seventh, or eighth aspects, wherein the underlying polymeric membrane is at least partially coated with a free-radical polymerized polymer, wherein the polymer is prepared from monomers comprising about 3 to about 10 weight percent of acrylamido propyl trimethylammonium chloride, and wherein the ethylenically-unsaturated monomers further comprise dimethylacrylamide and methylene bis acrylamide.

In a fifteenth aspect, the disclosure provides a method for removing anionic contaminants from a polar solvent composition, which comprises passing said composition through the membrane of any one of the first through the thirteenth aspects.

In a sixteenth aspect, the disclosure provides the method of the fifteenth aspect, wherein the polar solvent composition is comprised of a solvent chosen from at least one of water, C₁-C₆ alcohols, glycols, and glycol ethers.

In a seventeenth aspect, the disclosure provides the method of the fifteenth aspect, wherein the polar solvent composition is comprised of a solvent chosen from at least one of methanol, ethanol, isopropanol, butanol, C₂-C₄ diols, C₂-C₄ triols, tetrahydrofurfuryl alcohol, 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol), dichloromethane, chloroform, acetic acid, propionic acid, trifluoroacetic acid, tetrahydrofuran, N-methylpyrrolidinone, cyclohexylpyrrolidinone, N-octylpyrrolidinone, N-phenylpyrrolidinone, methyldiethanolamine, methyl formate, N, N-dimethyl formamide, dimethylsulfoxide, tetramethylene sulfone, diethyl ether, phenoxy-2-propanol, propriophenone, ethyl lactate, ethyl acetate, ethyl benzoate, acetonitrile, acetone, ethylene glycol, propylene glycol, 1,3-propanediol, dioxane, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, propylene glycol phenyl ether, ethylene glycol monophenyl ether, diethylene glycol monophenyl ether hexaethylene glycol monophenylether, dipropylene glycol methyl ether acetate, tetraethylene glycol dimethyl ether, dibasic ester, glycerine carbonate, N-formyl morpholine, triethyl phosphate, and combinations thereof.

In an eighteenth aspect, the disclosure provides the method of the sixteenth aspect, wherein the C₁-C₆ alcohol is isopropanol.

In a nineteenth aspect, the disclosure provides the method of any one of the fifteenth through eighteenth aspects, wherein the anionic contaminant is chosen from one or more of halides, phosphates, nitrates, nitrites, sulfites, and sulfates.

In a twentieth aspect, the disclosure provides the method of any one of the fifteenth through the eighteenth aspects, wherein the anionic contaminant is chosen from fluoride, chloride, and phosphate ions.

In a twenty-first aspect, the disclosure provides a composite membrane comprising a first membrane and a second membrane, an output facing surface of the first membrane in contact with an input facing surface of the second membrane,
wherein the first membrane or the second membrane comprises a porous membrane having ionizable nitrogen functional groups at least at the surface of the membrane, wherein at least a portion of the ionizable nitrogen functional groups are associated with a hydroxide anion;
and the second membrane is different from the first membrane.

In a twenty-second aspect, the disclosure provides the composite membrane of the twenty-first aspect, wherein the membrane is capable of removing anionic contaminants from a polar solvent composition.

In a twenty-third aspect, the disclosure provides a filter comprising the membrane of any one of the first through the fourteenth aspects, the twenty-first, or the twenty-second aspects.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A porous membrane comprising ionizable nitrogen functional groups at least at the surface of the membrane, wherein at least a portion of the ionizable nitrogen functional groups are associated with a hydroxide anion.

2. The membrane of claim 1, wherein the membrane is capable of removing anionic contaminants from a polar solvent composition.

3. The membrane of claim 2, wherein the anionic contaminants are chosen from chloride, fluoride, bromide, nitrate, nitrite, sulfate, and phosphate ions.

4. The membrane of claim 1 wherein the ionizable nitrogen functional groups are grafted to the membrane.

5. The membrane of claim 1, having a coating and wherein the ionizable nitrogen functional groups are at least at the surface of the coating on the membrane.

6. The membrane of claim 5, wherein the coating is a polymeric material formed from the free radical reaction of ethylenically-unsaturated monomers, wherein at least a portion of the ethylenically-unsaturated monomers are ethylenically-unsaturated monomers having ionizable nitrogen functional groups.

7. The membrane of claim 6, wherein the ethylenically-unsaturated monomers having ionizable nitrogen functional groups are chosen from 2-(dimethylamino)ethyl acrylate, [2-(acryloyloxy)ethyl]trimethylammonium, 2-aminoethyl methacrylate, N-(3-aminopropyl) methacrylate, 2-(dimethylamino)ethyl methacrylate, [3-(methacryloylamino)propyl] trimethylammonium, [2-(methacryloyloxy)ethyl]trimethylammonium, acrylamidopropyl trimethylammonium, 2-aminoethyl methacrylamide, N-(2-aminoethyl) methacrylamide, N-(3-aminopropyl)-methacrylamide, diallyldimethylammonium, allylamine, vinyl imidazolium, vinyl pyridinium, and vinyl benzyl trimethyl ammonium, or a hydroxide, or a halide or hydrohalide salt thereof.

8. The membrane of claim 6, wherein the ethylenically-unsaturated monomer having ionizable nitrogen functional groups comprises acrylamido propyl trimethylammonium chloride.

9. The membrane of claim 6, wherein the ethylenically-unsaturated monomers are further chosen from monomers which are uncharged, negatively-charged, or zwitterionic.

10. The membrane of claim 6, wherein the ethylenically-unsaturated monomers having ionizable nitrogen functional groups is a quaternary ammonium group associated with a hydroxyl anion.

11. The membrane of claim 5, wherein the coating is a polyallylamine or a polyvinylamine.

12. The membrane of claim 1, wherein the membrane has been treated with an alkyl or aryl phosphonium hydroxide, ammonium hydroxide, or an organic ammonium hydroxide.

13. The membrane of claim 12, wherein the hydroxide compound is chosen from ammonium hydroxide, tetramethylammonium hydroxide, tetraethylammonium hydroxide, tetrapropylammonium hydroxide, tetrabutylammonium hydroxide, tributylmethylammonium hydroxide, benzyltrimethylammonium hydroxide, choline hydroxide, tetrabutylphosphonium hydroxide, tetramethylphosphonium hydroxide, tetraethylphosphonium hydroxide, tetrapropylphosphonium hydroxide, benzyltriphenylphosphonium hydroxide, methyl triphenylphosphonium hydroxide, ethyl triphenylphosphonium hydroxide, N-propyl triphenylphosphonium hydroxide.

14. The membrane of claim 1, wherein the underlying polymeric membrane is at least partially coated with a free-radical polymerized polymer, wherein the polymer is prepared from monomers comprising about 3 to about 10 weight percent of acrylamido propyl trimethylammonium chloride, and wherein the ethylenically-unsaturated monomers further comprise dimethylacrylamide and methylene bis acrylamide.

15. A method for removing anionic contaminants from a polar solvent composition, the method comprising passing the polar solvent composition through the membrane of claim 1.

16. The method of claim 15, wherein the polar solvent composition is comprised of a solvent chosen from at least one of water, C₁-C₆ alcohols, glycols, and glycol ethers.

17. The method of claim 15, wherein the polar solvent composition is comprised of a solvent chosen from at least one of methanol, ethanol, isopropanol, butanol, C₂-C₄ diols, C₂-C₄ triols, tetrahydrofurfuryl alcohol, 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol), dichloromethane, chloroform, acetic acid, propionic acid, trifluoroacetic acid, tetrahydrofuran, N-methylpyrrolidinone, cyclohexylpyrrolidinone, N-octylpyrrolidinone, N-phenylpyrrolidinone, methyldiethanolamine, methyl formate, N, N-dimethyl formamide, dimethylsulfoxide, tetramethylene sulfone, diethyl ether, phenoxy-2-propanol, propriophenone, ethyl lactate, ethyl acetate, ethyl benzoate, acetonitrile, acetone, ethylene glycol, propylene glycol, 1,3-propanediol, dioxane, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether, tripropylene glycol n-propyl ether, propylene glycol n-butyl ether, dipropylene glycol n-butyl ether, tripropylene glycol n-butyl ether, propylene glycol phenyl ether, ethylene glycol monophenyl ether, diethylene glycol monophenyl ether hexaethylene glycol monophenylether, dipropylene glycol methyl ether acetate, tetraethylene glycol dimethyl ether, dibasic ester, glycerine carbonate, N-formyl morpholine, triethyl phosphate, and combinations thereof.

18. The method of claim 16, wherein the C₁-C₆ alcohol is isopropanol.

19. The method of claim 15, wherein the anionic contaminant is chosen from one or more of halides, phosphates, nitrates, nitrites, sulfites, and sulfates.

20. The method of claim 15, wherein the anionic contaminant is chosen from fluoride, chloride, and phosphate ions.

21. A composite membrane comprising:
a first membrane; and
a second membrane,
wherein an output facing surface of the first membrane in contact with an input facing surface of the second membrane,
wherein the first membrane or the second membrane comprises a porous membrane having ionizable nitrogen functional groups at least at the surface of the membrane, wherein at least a portion of the ionizable nitrogen functional groups are associated with a hydroxide anion, and
wherein the second membrane is different from the first membrane.

22. The composite membrane of claim 21, wherein the membrane is capable of removing anionic contaminants from a polar solvent composition.

23. A filter comprising the membrane of claim 1.

24. A filter comprising the membrane of claim 21.
